(19) United States
(12) Patent Application Publication
(10) Pub. No.: US 2017/0074598 A1
(43) Pub. Date: Mar. 16, 2017

(54) HEAT TRANSFER ARRANGEMENT FOR A MOTOR VEHICLE, AND MOTOR VEHICLE

(71) Applicant: Audi AG, lngolstadt (DE)

(72) Inventors: JOSEF WINKLER, Kipfenberg (DE); FRANK VOLLMER, lngolstadt (DE); TASSILO SCHOLLE, lngolstadt (DE); THOMAS HOFFMANN, Vohburg (DE); MARKUS STÖRMER, Berching (DE); ALFRED OTTOWITZ, Reichertshofen (DE); CHRISTIAN MEIXNER, lngolstadt (DE)

(73) Assignee: Audi AG, lngolstadt (DE)

(21) Appl. No.: 15/261,198

(22) Filed: Sep. 9, 2016

(30) Foreign Application Priority Data
Sep. 10, 2015 (DE) 10 2015 011 866.8

(51) Int. Cl. F28D 20/02; F28D 15/02; H01M 10/663; F28D 21/00; H01M 6/50; H01M 10/625; B60H 1/02; F28D 15/06

(52) U.S. Cl. CPC F28D 20/02; B60H 1/025; F28D 15/02; F28D 15/025; F28D 15/06; F28D 21/0003; H01M 6/5038; H01M 10/625; H01M 10/663; F28D 2020/0047

(57) ABSTRACT

A heat transfer arrangement for a motor vehicle includes a heat exchanger, a heat sink, and a heat pipe, with the heat pipe connected to the heat sink and connected via the first heat exchanger to a heat source of the motor vehicle. A latent heat accumulator is further operatively connected to the heat exchanger.

### CROSS-REFERENCES TO RELATED APPLICATIONS

This application claims the priority of German Patent Application, Serial No. 10 2015 011 866.8, filed Sep. 10, 2015, pursuant to 35 U.S.C. 119(a)-(d), the disclosure of which is incorporated herein by reference in its entirety as if fully set forth herein.

### BACKGROUND OF THE INVENTION

The present invention relates to a heat transfer arrangement for a motor vehicle, and to a motor vehicle.

The following discussion of related art is provided to assist the reader in understanding the advantages of the invention, and is not to be construed as an admission that this related art is prior art to this invention.

A heat transfer arrangement is provided in a motor vehicle to transfer heat from the heat source to a heat sink. Normally, the heat source has a higher temperature than the heat sink so that heat can be transferred from the heat source to the heat sink through heat conduction, convection and/or heat radiation. Excess heat generated by the heat source may, for example, be made available for different purposes. The heat sink can be realized, for example, by using a coolant circuit of the motor vehicle.

It would be desirable and advantageous to provide an improved heat transfer arrangement to obviate prior art shortcomings and to realize an efficient use of heat produced by a heat source.

### SUMMARY OF THE INVENTION

According to one aspect of the present invention, a heat transfer arrangement for a motor vehicle includes a heat exchanger, a heat sink, a heat pipe connected to the heat sink and connected via the first heat exchanger to a heat source of the motor vehicle, and a latent heat accumulator operatively connected to the heat exchanger.

The provision of the latent heat accumulator results in a temporary storage of heat that has been generated by the heat source and transferred in particular to the heat exchanger for transfer to the heat pipe. For example, the heat pipe can be connected to the heat source via the latent heat accumulator, so that heat given off by the heat source is transferred exclusively via the latent heat accumulator to the heat pipe. As an alternative, provision may also be made to position the heat pipe and the latent heat accumulator parallel to one another in heat transfer connection with the heat source. Accordingly, heat can be transferred directly from the heat source to the heat pipe and heat can be absorbed parallel thereto by the latent heat accumulator, so long as the heat source generates heat.

The provision of the latent heat accumulator has the advantage that heat is supplied to the heat sink via the heat pipe even during a time period in which the heat source does not generate heat, i.e. when the temperature of the heat source is smaller than or equal to the temperature of the heat sink. This heat is drawn from the latent heat accumulator. For example, when the motor vehicle is at a standstill and the heat source thus cools down to assume a temperature which is smaller than or equal to the temperature of the heat sink, heat can now be forwarded rapidly to the heat sink, when the motor vehicle and its internal combustion engine are operated again, without the heat source being required to provide this heat. Rather, heat provided to the heat sink can be taken from the latent heat accumulator which can then be recharged, when the heat source again generates heat.

A latent heat accumulator is to be understood as a heat storage device which exploits a phase change of a heat storage medium. The heat storage medium of the latent heat accumulator can thus also be referred to as phase change material (PCM). The phase change material is advantageously chosen to have a melting temperature which is greater than the temperature of the heat source during a shutdown of the motor vehicle over a longer time period, i.e. in particular a typical ambient temperature of the motor vehicle. At the same time, the melting temperature should be smaller than a temperature, which is reached by the heat source during operation of the motor vehicle, in particular during stationary operation.

According to another advantageous feature of the present invention, the heat pipe can be connected to the heat exchanger via the latent heat accumulator. As a result, heat can be transferred via the heat exchanger from the heat source to the heat pipe. The heat exchanger can be directly connected to the heat source. For example, a fluid of the heat source, e.g. exhaust gas, can flow through the heat exchanger. The heat pipe is hereby connected, advantageously exclusively, to the heat exchanger via the latent heat accumulator, as already described above. The latent heat accumulator is thus arranged, with respect to the heat flow from the heat source in the direction of the heat pipe, between the heat source or heat exchanger, on one hand, and the heat pipe, on the other hand.

According to another advantageous feature of the present invention, the heat exchanger can be directly connected to the heat source and directly connected to the heat pipe, with the latent heat accumulator having at least one area which embraces the heat exchanger. This has also been already described above. Again, the heat exchanger is directly connected to the heat source, and thus is flowed through, for example, by fluid of the heat source. In this configuration, the heat pipe is, however, not indirectly connected via the latent heat accumulator to the heat exchanger, but rather directly thereto. Thus, heat removed from the heat source via the heat exchanger can be directly transferred to the heat pipe. Since, at the same time, the latent heat accumulator has least one area which embraces the heat exchanger, heat generated by the heat source can be used for charging the latent heat accumulator. Such a configuration has the benefit that heat can be provided to the heat sink via the heat pipe in a substantially quicker way, since there is no need to first charge the latent heat accumulator, before heat is transferred via the heat pipe.

According to another advantageous feature of the present invention, the heat pipe can be configured switchable. Thus, the heat pipe includes at least one switching device by which the heat flow through the heat pipe can be selectively enabled or cut. For example, the switching device can be configured discretely switchable, so that the heat transfer via the heat pipe can be selectively completely interrupted or completely established. Of course, the switching device may also be configured to allow a gradual adjustment of the heat flow through the heat pipe.

The switching device influences, for example, the medium in the heat pipe and its flow through the heat pipe. The switching device may be realized in the form of a valve for adjusting a throughflow cross section of the heat pipe, so that the flow rate of fluid flowing through the heat pipe can be adjusted. This may be realized by open-loop control and/or closed-loop control.

According to another advantageous feature of the present invention, the heat pipe can be configured as closed evaporator-condenser system, also referred to as heatpipe, or as thermosiphon. The evaporator-condenser system has a capillary structure which permits a flow of condensed medium, while evaporated medium flows outside the capillary structure. The heatpipe has the advantage of operating substantially position-independently. In the case of a thermosiphon, medium circulates as a result of the impact of gravity. Condensed medium is pulled down by gravity so to upwardly push evaporated medium or warmer medium which thus has a smaller density. Medium is thus contained in the heat pipe in a fluidtight manner and is passively transported inside the heat pipe, i.e. as a result of density differences between warmer and colder media or as a result of a pressure drop between evaporated and condensed media.

According to another advantageous feature of the present invention, the latent heat accumulator can include a phase change material in the form of a liquid metal or liquid semiconductor material. An example of a liquid metal may involve an aluminum alloy having a melting point of preferably 250° C. to 350° C., especially about or precisely 300° C. In addition or as an alternative, the alloy may contain indium and/or tin.

According to another advantageous feature of the present invention, a further heat exchanger can be provided, which includes a heat accumulator, with the heat pipe being connected to the heat sink via the further heat exchanger. Advantageously, the heat accumulator of the further heat exchanger is a latent heat accumulator. As a result, the heat pipe is connected not only via the heat exchanger to the heat source but has the further heat exchanger on its side distal to the heat source, for realizing a heat transfer connection between the heat pipe and the heat sink. A heat accumulator, which may also be configured as latent heat accumulator, may also be operatively connected to the further heat exchanger.

Provision may now be made for connecting the heat pipe via the heat accumulator to the further heat exchanger. Thus, the heat pipe is not directly connected to the heat sink, but rather the heat transfer connection is implemented, advantageously exclusively, via the further heat exchanger and the heat accumulator. As an alternative, it is, of course, possible to connect the further heat exchanger directly to the heat sink and directly to the heat pipe. In such a configuration, the heat accumulator, e.g. the further latent heat accumulator, embraces at least one area of the further heat accumulator.

According to another aspect of the present invention, a motor vehicle includes a: heat transfer arrangement which includes a heat source, a heat exchanger, a heat sink, a heat pipe connected to the heat source and the heat sink via the heat exchanger, and a latent heat accumulator operatively connected to the heat exchanger.

According to another advantageous feature of the present invention, the heat source can be represented by an exhaust pipe of the motor vehicle and/or the heat sink can be a heater. The heater can be a passenger compartment heater or a battery heater. The battery heater can hereby be used for maintaining an electric energy store, such as a battery or accumulator, at a moderate temperature. Heat is generated by the exhaust pipe or exhaust flowing through the exhaust pipe and produced by a drive unit, such as e.g. an internal combustion engine. As a result, heat contained in the exhaust is not simply released into the atmosphere but stored in the latent heat accumulator and supplied to the heat sink.

According to another advantageous feature of the present invention, a plurality of heat pipes can be provided and connected to the heat source and to a plurality of different heat sinks, respectively. Such a configuration may, of course, be provided in general within the scope of the heat transfer device and thus applicable not only for motor vehicles. By using several heat pipes, it becomes possible to draw heat from the heat source and supply it to the different heat sinks, respectively. The heat sinks may hereby be configured, as described above. For example, one of the heat sinks may be a passenger compartment heater and another one of the heat sinks may be a battery heater. Of course, other configurations can be realized as well. Advantageously, at least one, in particular all, of the heat pipes is switchable.

### BRIEF DESCRIPTION OF THE DRAWING

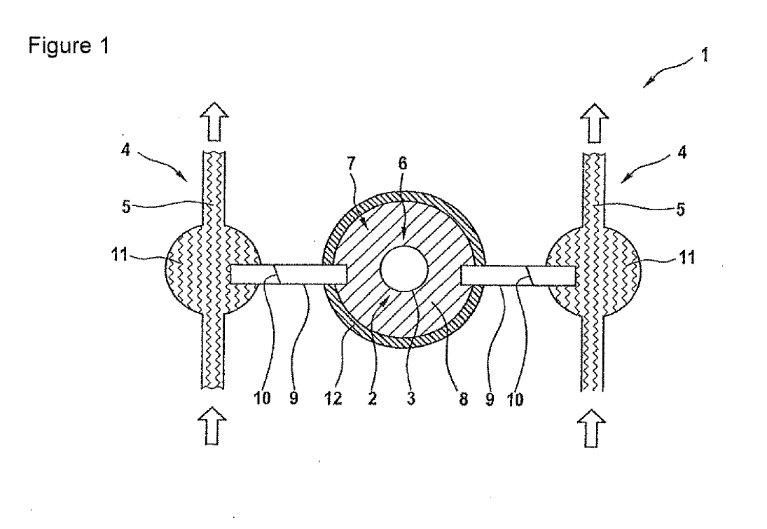

Other features and advantages of the present invention will be more readily apparent upon reading the following description of currently preferred exemplified embodiments of the invention with reference to the accompanying drawing, in which the sole FIG. 1 shows a schematic illustration of a heat transfer device for a motor vehicle.

### DETAILED DESCRIPTION OF PREFERRED EMBODIMENTS

The depicted embodiment is to be understood as illustrative of the invention and not as limiting in any way. It should also be understood that the FIGURE may not necessarily be to scale. In certain instances, details which are not necessary for an understanding of the present invention or which render other details difficult to perceive may have been omitted.

Turning now to FIG. 1, there is shown a schematic illustration of a heat transfer device, generally designated by reference numeral 1, for use in a motor vehicle, for example. The heat transfer device 1 includes a heat source 2, which in the non-limiting example here, is represented by an exhaust pipe 3. Hot exhaust gas produced, for example, by an internal combustion engine of the motor vehicle, flows through the exhaust pipe 3 during operation of a drive unit of the motor vehicle. The heat transfer device 1 further includes at least one heat sink 4, here, by way of example, several heat sinks 4. It is to be understood that the principles described in the following description with respect to one of the heat sinks 4 are generally applicable to the other one of the heat sinks.

The heat sink 4 may involve any device of the motor vehicle. For example, a coolant circuit of the motor vehicle may be used as a heat sink, so that coolant flowing in the cooling circuit can be heated more rapidly by heat contained in the exhaust, after the internal combustion engine has been started. As a result, the internal combustion engine can be brought to operating temperature quicker to enable a more efficient execution in particular of an aftertreatment. In the non-limiting example of FIG. 1, the heat sink 4 is a heating circuit 5 of an otherwise not shown heating system which may be a passenger compartment heating system or battery heater for example. Connected to the heat source 2 is a heat exchanger, which is not illustrated in greater detail. Exhaust gas flowing in the exhaust pipe 3 flows through the heat exchanger. The exhaust pipe 3 itself represents here, for example, the heat exchanger, which has been generally designated in FIG. 1 by reference numeral 6 for sake of simplicity. Associated to the heat exchanger 6 is a latent heat accumulator 7 which includes a phase change material 8. The phase change material 8 embraces or surrounds hereby the exhaust pipe 3.

Heat from the heat source 2 is transferred to the heat sink 4 via a heat pipe 9, e.g. in the form of an evaporator-condenser system or heatpipe. The term “heat pipe” is to be understood as relating to an evaporation heat transfer device, i.e. heat exchanging device, which uses evaporation heat of a medium. A high heat flux density can be realized by using a heat pipe.

The heat pipe 9 is switchable and includes for this purpose a valve 10, by which the flow of a medium in the heat pipe 9 can be influenced. The heat pipe 9 is connected via the latent heat accumulator 7 to the heat exchanger 6. Thus, the heat pipe 9 is not in direct connection with the heat exchanger 6 or heat source 2 but only indirectly via the latent heat accumulator 7 and its phase change material 8.

In the non-limiting example of FIG. 1, the heat pipe 9 has one end sized to extend into the phase change material 8. On its end distal to the heat source 2, the heat pipe 9 is in heat transfer connection with the heat sink 4. For this purpose, provision can be made for a further heat exchanger, not shown in greater detail. Currently preferred is, however, the provision of a heat accumulator, e.g. a further latent heat accumulator, in the heating circuit 5. The heat pipe 9 is in heat transfer connection exclusively via the heat accumulator 11 with the heat sink 4. Thus, there is no direct heat transfer between the heat pipe 9 and the heat sink 4 but rather only an indirect heat transfer via the heat accumulator 11.

In order to improve the storage effect of the latent heat accumulator 7, an insulation 12 is provided which surrounds the phase change material 8, advantageously in its entirety. As shown in FIG. 1, the heat pipe 9 extends through the insulation 12 and projects into the phase change material 8. Of course, it is also possible that the heat pipe 9 is in heat transfer connection with the heat source 2 not only indirectly via the phase change material 8 or latent heat accumulator 7. Rather, provision may be made for the heat pipe 9 to extend through the phase change material 8 up to the exhaust pipe 3 or heat exchanger 6, so that both the heat pipe 9 and the latent heat accumulator 7 or its phase change material 8 are in direct heat transfer connection with the heat source 2 and the heat exchanger 6.

The phase change material 8 is provided in the form of a liquid metal, for example, and has a melting point of advantageously 250° C. to 350° C., especially about or precisely 300° C. The presence of the insulation 12 enables to store heat with little loss in the latent heat accumulator 7 over several hours. Advantageously, the insulation 12 is configured such that after twelve hours of stoppage of the motor vehicle, at least 50% of stored heat is still available in the latent heat accumulator 7.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A heat transfer arrangement for a motor vehicle, comprising:
a first heat exchanger;
a heat sink;
a heat pipe connected to the heat sink and connected via the first heat exchanger to a heat source of the motor vehicle; and
a latent heat accumulator operatively connected to the first heat exchanger.

2. The heat transfer arrangement of claim 1, wherein the heat pipe is connected to the first heat exchanger via the latent heat accumulator.

3. The heat transfer arrangement of claim 1, wherein the first heat exchanger is directly connected to the heat source and directly connected to the heat pipe, said latent heat accumulator having at least one area which embraces the first heat exchanger.

4. The heat transfer arrangement of claim 1, wherein the heat pipe is switchable.

5. The heat transfer arrangement of claim 1, further comprising a valve received in the heat pipe to allow adjustment of a throughflow cross section of the heat pipe

6. The heat transfer arrangement of claim 1, wherein the heat pipe is configured as closed evaporator-condenser system or as thermosiphon.

7. The heat transfer arrangement of claim 1, wherein the latent heat accumulator includes a phase change material in the form of a liquid metal or liquid semiconductor material.

8. The heat transfer arrangement of claim 1, further comprising a second heat exchanger including a heat accumulator, said heat pipe being connected to the heat sink via the second heat exchanger.

9. The heat transfer arrangement of claim 7, wherein the heat accumulator of the second heat exchanger is a latent heat accumulator.

10. A motor vehicle, comprising:
a heat source; and
a heat transfer arrangement including a heat exchanger, a heat pipe connected to the heat sink and connected via the first heat exchanger to a heat source of the motor vehicle, and a latent heat accumulator operatively connected to the first heat exchanger.

11. The motor vehicle of claim 10, wherein the heat source is an exhaust pipe of the motor vehicle and/or wherein the heat sink is a heater.

12. The motor vehicle of claim 11, wherein the heater is a passenger compartment heater or a battery heater.

13. The motor vehicle of claim 10, further comprising a plurality of said heat pipe connected to the heat source and to a plurality of different ones of said heat sink, respectively.
